(19) United States
(12) Patent Application Publication
(10) Pub. No.: US 2021/0086326 A1
(43) Pub. Date: Mar. 25, 2021

(54) Suctioning Device Having Optimized Dust Suctioning

(71) Applicant: HOMAG GmbH, Schopfloch (DE)

(72) Inventor: Torben HELLMANN, Bielefeld (DE)

(21) Appl. No.: 16/635,144

(22) PCT Filed: Aug. 2, 2018
(86) PCT No.: PCT/EP2018/070993

§ 371 Date: Jan. 29, 2020

(30) Foreign Application Priority Data
Aug. 4, 2017 (DE) 102017117715.9

(51) Int. Cl. B24B 55/08; B23Q 11/00; B24B 49/10

(52) U.S. Cl. CPC B24B 55/08; B24B 49/10; B23Q 11/006

(57) ABSTRACT

By means of the present invention, a suctioning device (1) for a grinding device (100) and a method for suctioning particles produced at a grinding device (100) are provided. The suctioning device (1) has at least one suctioning channel (2), through which suctioned air can flow, and one first manipulation apparatus (3) arranged in the suctioning channel (2). The first manipulation apparatus (3) is designed to be able to directly or indirectly influence a boundary layer (G), in particular a boundary layer (G) of a circulating grinding element (111) of a grinding device (100), in particular to be able to reach into the boundary layer (G).

### TECHNICAL FIELD

The present invention relates to a suctioning device for a grinding device, preferably a belt grinding device, in particular for a wide belt grinding device, for optimized suctioning of particles produced during machining of a workpiece, which preferably consists at least in part of wood, composite wood materials, wood substitute materials, plastic, metal or similar. In addition, the present invention relates to a method for suctioning particles produced during machining on a grinding device, and to a grinding device having a suctioning device according to the invention.

The (dust) suctioning device and method of the present invention are particularly used in wide belt grinding machines, preferably for machining plate-shaped workpieces.

### PRIOR ART

Devices and methods for suctioning particles produced during machining, in particular chipping, are already known from the prior art. A device for removing grinding dust from workpieces in a grinding device which is suitable for removing grinding dust from workpieces in a grinding device, in particular in a wide belt grinding device, is known from DE 42 32 830, for example. To this end, a compressed air supply is designed with an outlet opening arranged downstream in or against the direction of transport of the workpiece in the grinding zone. The grinding dust thus discharged is suctioned with a suctioning device. To minimize unnecessary stirring up of dust, this device is designed with a plurality of actuatable blowing devices which are activated depending on the size of the workpiece from which dust is to be discharged.

Furthermore, DE 25 02 806 A1 describes a dedusting device for a grinding device, wherein in addition to the branch of the grinding element running upwards a vertically aligned air supply fed from above is arranged, which guides the escaping air in a strong jet towards the bottom end of the upward-running branch of the grinding element directly next to an intake opening of a suction line connected to a suctioning device and discharging the grinding dust, and a screen which works together with the grinding element is provided, which essentially confines the influx of air to the intake opening region to the air supply.

Although known suctioning devices have proven successful in practical applications, the requirements for such devices are continuously growing. In particular, the maintenance effort, use of materials and machining quality are becoming increasingly important, meaning in particular that there is a need for energy-efficient suctioning devices with increased suction capacity.

### SUBJECT-MATTER OF THE INVENTION

The purpose of the present invention is to provide a suctioning device for a grinding device, a method for suctioning particles produced during a machining operation on a grinding device and a grinding device having the suctioning device according to the invention, which enable a high suction capacity for suctioning particles and the associated high machining quality, with low use of energy and materials. The aim in particular is to improve suction capacity in relation to particles trapped in a boundary layer of the grinding element.

The object of the invention is solved by a suctioning device according to claim 1, a grinding device according to claim 11 and a method according to claim 15. Preferred further developments of the invention are given in the dependent claims, whereby the subject-matter of the dependent claims relating to the device(s) can be used within the method and machining device, and vice versa.

One of the ideas behind the present invention is to provide a suctioning device and a method which is/are able to break up the boundary layer of a grinding element produced by the running movement, in particular the circulating movement, of the grinding element, or preferably to eliminate the layer. The idea is that this will release particles trapped in the boundary layer so that they can be suctioned.

Using the proposed suctioning device and the proposed method, it is possible to break up or even completely eliminate the boundary layer of a grinding element while operating the grinding element, in turn allowing the particles trapped in the boundary layer, so to speak, to be released. In other words, it allows the particles to break out of the boundary layer. This improves the efficiency of the suctioning device, without having to increase the suction capacity of the suctioning device. Furthermore, the chipping result (grinding result) is also improved, as the grinding element can be cleaned more successfully. A well cleaned grinding element means that the grinding device is able to achieve a more uniform and improved surface.

In addition, this also extends the service life of the grinding element, thus contributing in a positive manner to the reduction of manufacturing costs and maintenance costs. In addition, the removal of dust from the interior of the grinding device can be improved, having an advantageous effect on reducing the wear of components of the grinding device and minimizing cleaning costs.

According to an embodiment of the present invention, the suctioning device has the following for a grinding device having a grinding element, in particular for a belt or wide belt grinding device, for suctioning particles produced during the machining of a workpiece which preferably consists at least in part of wood, composite wood materials, wood substitute materials, plastic, metal or similar: at least a suctioning channel through which suctioned air can flow, and a first manipulation apparatus arranged in the area of the suctioning channel which can be designed in the form of a flow body, for example. This first manipulation apparatus is set up to influence a boundary layer of a grinding element of a grinding device, in particular to reach into the boundary layer. Reaching into the boundary layer can be direct or indirect.

A boundary layer in the context of the present invention relates for example to a laminar and/or turbulent layer of air which forms on a grinding element if the grinding element is running. This boundary layer is created in particular due to the fact that the grinding element, in particular the endless grinding belt, is operated at a high cutting speed (grinding belt circulation speed), generally between 0.5 ms⁻¹ and 30 ms⁻¹, but this speed can be considerably higher in high-performance applications.

As illustrated in FIG. 1, a layer of air forms around the circulating grinding element. This layer of air can be both laminar and turbulent. This effect is referred to as the boundary layer phenomenon or “boundary layer effect”. This layer of air (boundary layer) prevents a “break-out” of particles from the surface of the grinding element, thus making cleaning the grinding element more difficult. These particles may be, inter alia, grinding swarf and abrasion debris from the grinding element.

Furthermore, a manipulation apparatus in the context of the present invention, in particular a boundary layer manipulation apparatus (for the purposes of simplification, reference will hereinafter be made merely to a manipulation apparatus), relates to device which is designed to manipulate the boundary layer sticking to the grinding belt. In other words, to influence the boundary layer. To this end, the manipulation apparatus can directly or indirectly influence the boundary layer. The manipulation apparatus can, for example, be designed in the form of a flow body which reaches into the boundary layer to directly influence the boundary layer. On the other hand, it is also possible to provide an “air knife” as a manipulation apparatus.

In addition, a direct or indirect influence on the boundary layer in the context of the present invention is understood to mean that the formation or form of the boundary layer is influenced using a means (of manipulation apparatus) to weaken, break up or, possibly, eliminate the boundary layer.

In accordance with a further embodiment of the present invention, the first manipulation apparatus is arranged in the area of the suctioning channel so as to be movable, in particular pivotable, with the first manipulation apparatus being preferably movable such that an end of the first manipulation apparatus which is facing the boundary layer approaches or moves away from the boundary layer. In the area of the suctioning channel in the context of the present invention is understood to mean that the first manipulation apparatus is arranged in a flow area of the air suctioned by the suctioning device, in particular of a suctioned flow of particles, the flow of particles in particular comprising the particles released from the boundary layer.

It is thus possible to easily alter the influence of the manipulation apparatus on the boundary layer of the grinding element, in particular to adapt it to changed framework conditions. Changed framework conditions are understood to mean that the material of the workpiece to be machined, for example from softwood to hardwood, the grinding element type, the grinding element grain, the circulation speed of the grinding element, the contact force of the grinding element on the workpiece to be machined or another similar factor has been altered. The shape of the boundary layer and the chip formation behaviour change according to the altered framework conditions; the provision of a possibility of adjusting the influence of the manipulation apparatus on the boundary layer is therefore advantageous, in particularly with regard to a sufficient weakening of the boundary layer and the associated increase in efficiency of the suctioning device.

Furthermore, it is preferred that the suctioning device additionally has a second manipulation apparatus which is arranged in the suctioning channel so as to be movable, in particular pivotable, with the second manipulation apparatus being preferably movable such that an end of the second manipulation apparatus that is facing the boundary layer approaches or moves away from the boundary layer.

The provision of a second manipulation apparatus offers the advantage that if a full break-up or elimination of the boundary layer were not possible using the first manipulation apparatus, this can be done by the second manipulation apparatus. Furthermore, the better option is to optimally guide the air (particle flow) that is suctioned by the suctioning device and mixed with the particles released from the boundary layer in the direction of the suctioning device using two manipulation apparatuses.

In addition, it is advantageous if at least one sealing device is provided which is arranged in the suctioning channel such that it can seal at least a part of a cross-section of the suctioning channel so that no suctioned air can flow through this part of the cross-section.

Using the sealing device, it is possible to seal a cross-section, in particular an intake cross-section, of the suctioning channel of the suctioning device, in other words to reduce the size of the cross-section of the suctioning channel. It is particularly advantageous here to seal those areas of the cross-section of the suctioning channel that are not required to discharge the air (particle flow) suctioned by the suctioning device. It is thus possible to reduce the power required by an extraction fan and in turn save energy costs.

Furthermore, a blowing air device can be provided, with the blowing air device having a plurality of nozzles which are preferably provided in the first and/or second manipulation apparatus, in particular in a flow body of the respective manipulation apparatus, and flow channels which supply the nozzles with a fluid, in particular compressed air. It is also possible in this scenario to only provide boreholes in the first and/or second manipulation apparatus, in particular in the flow body of the respective manipulation apparatus, from each of which a fluid (e.g. blowing air) is discharged at high speed.

Using the blowing device, it is possible to improve the influence on the boundary layer and therefore the break-up or elimination of the boundary layer. Conversely, this offers the possibility of increasing a distance between the manipulation apparatuses, in particular between an end of the manipulation apparatus facing the grinding element and the grinding belt, while still being able to exert sufficient influence on the boundary layer. This enables the risk of the grinding element, in particular a grinding element that has already been in use for a long time and is therefore worn, coming into contact with the manipulation apparatuses to be reduced.

In accordance with a further embodiment of the present invention, the fluid is selected from one of the following: air, air that is mixed with solid particles and/or liquid particles and/or vapour, air that is mixed with dry ice, CO₂ snow and de-ionized air. The solid particles in this case are preferably particles of solid matter, in particular wood or metal chippings or offcuts, and the liquid particles are preferably water particles.

If the fluid of the blowing device is mixed with particles, the kinetic energy (pulse) of the fluid can be increased, thereby increasing the effect of the blowing device, in particular the influence of the discharged fluid on the boundary layer.

Furthermore, it is advantageous if the first manipulation apparatus and/or the second manipulation apparatus, in particular a flow body of the manipulation apparatus, has/have an aerodynamic design, and/or the surface of the first manipulation apparatus and/or the second manipulation apparatus is designed as a sharkskin surface or as a surface with dimples (golf ball).

This prevents the occurrence of an unnecessarily high air resistance, which would increase the blowing power required by the suctioning device (vacuum device), and undesirable noise emissions.

Furthermore, it is preferred that the two manipulation apparatuses are alignable in relation to the boundary layer so that two suctioned air flows, in particular suctioned particle flows, can be created.

In accordance with a further embodiment of the present invention, the suctioning device has one or more sensors for detecting a position, in particular an angular position, of the first manipulation apparatus and/or the second manipulation apparatus and/or the sealing device.

In this way, it is possible to detect a position, alignment or angular position of the individual manipulation apparatuses and/or the sealing device, allowing precise positioning, alignment and/or angular adjustment of the respective components. To this end, each of the respective components can have a separate actuator which is able to perform the pivotal movement of the manipulation apparatuses and/or sealing device in a preferably incremental manner. To realize the incremental pivotal movement, it is advantageous if the actuators are designed as a step motor, linear actuator, spindle drive or similar.

Furthermore, it is advantageous that the suctioning device is designed so as to be arranged in a deflection area of a tensioning roller and/or a deflection roller of the grinding element, with the first manipulation apparatus and/or the second manipulation apparatus in particular being able to be brought into contact at least roughly with the tensioning roller.

Furthermore, the present invention relates to a grinding device for grinding workpieces which preferably consist at least in part of wood, composite wood materials, wood substitute materials, plastic, metal or similar, said grinding device having: at least a grinding element, the grinding element having a boundary layer during a grinding operation, and the suctioning device described above.

Using the proposed grinding device, it is possible to break up or even completely eliminate the boundary layer of a grinding element during operation of the grinding device, in particular during a grinding operation, which in turn allows particles trapped in the boundary layer, so to speak, to be released. In other words, it allows the particles to break out of the boundary layer. This improves the efficiency of the suctioning device, without having to increase the suction capacity of the suctioning device. Furthermore, the chipping result (grinding result) can be improved, as the grinding element can be cleaned more successfully. A well cleaned grinding element means that the grinding device can achieve a more uniform and improved surface.

In addition, the service life of the grinding element can be increased, thus contributing in a positive manner to the reduction of manufacturing costs and maintenance costs. In addition, removal of dust from the interior of the grinding device can be improved, which is positive for the reduction of the wear of components of the grinding device, and which minimizes cleaning costs.

In accordance with a further embodiment of the present invention, the grinding device also has a grinding unit with a tensioning roller and/or a deflection roller, wherein the suctioning device is provided in the vicinity, in particular in a deflection area, of the tensioning roller or deflection roller of the grinding element, and wherein in particular the first manipulation apparatus and/or the second manipulation apparatus is/are movable, in particular pivotable, so that it/they can be brought into contact at least roughly with the tensioning roller.

It is thus possible to use the kinetic energy (inertia) of the particles that are trapped or embedded in the boundary layer to release the particles from the boundary layer and/or to break up or eliminate the boundary layer. This is understood to mean that the inertia behaviour of the particles which acts during deflection of the grinding element on the deflection roller or tensioning roller radially outwards, in other words away from the deflection roller or tensioning roller, is used to release the particles from the boundary layer and/or to break up or eliminate the boundary layer.

Furthermore, it is preferred that the suctioning device and/or the grinding unit, in particular the tensioning roller, are movable in order to be able to reduce or increase a distance between the suctioning device and grinding unit, in particular between the first manipulation apparatus and/or the second manipulation apparatus and the tensioning roller.

It is thus possible to easily manipulate the effect (influence) of the manipulation apparatus(es) on the boundary layer of the grinding element and thus adapt the effect of the manipulation apparatus(es) to changed parameters, in particular machining parameters (machining conditions).

Furthermore, it is preferred that the grinding device has a control device that is configured to perform at least a positioning and/or alignment and/or angular adjustment of the first manipulation apparatus, the second manipulation apparatus or the sealing device based on at least one parameter selected from one of the following: grinding element type, grinding element grain, circulation speed of the grinding element, material of the workpiece to be machined, particle size, suctioning speed.

It is thus possible to automatically adjust the positioning and/or alignment and/or angular position of the first manipulation apparatus, the second manipulation apparatus or the sealing device. More specifically, the optimal settings (position, alignment and/or angular position) for a range of different machining scenarios (grinding element type, grinding element grain, circulation speed of the grinding element, material of the workpiece to be machined, particle size) are stored in the control system and the control system determines the optimum settings for the manipulation apparatuses and/or the sealing device according to the machining parameters selected.

In addition, the present invention relates to a method for suctioning particles produced at a grinding device, in particular when machining a workpiece, which preferably consists at least in part of wood, composite wood materials, wood substitute materials, plastic, metal or similar, preferably using the suctioning device described above, said method comprising the following steps:

Creation of at least one suctioned air flow in a suctioning channel for suctioning at least particles sticking to a grinding element;

Positioning and/or alignment of a first manipulation apparatus such that the first manipulation apparatus influences a boundary layer of the grinding element, in particular reaches into the boundary layer.

### BRIEF DESCRIPTION OF THE DRAWINGS

FIG. 1 shows a schematic representation of the formation of a boundary layer on a circulating grinding element.

FIG. 2 shows an embodiment of a grinding device according to the present invention in which machining takes place in the same direction.

FIG. 3 shows an embodiment of a grinding device according to the present invention in which machining takes place in the counter direction.

FIG. 4 shows the embodiment of the grinding device from FIG. 2 in which the grinding unit is in the change position.

### DETAILED DESCRIPTION OF THE PREFERRED EMBODIMENTS

Preferred embodiments of the present invention will be described in detail below using the enclosed figures. Each of the further modifications of certain features cited in this context can be combined individually with each other to create new embodiments.

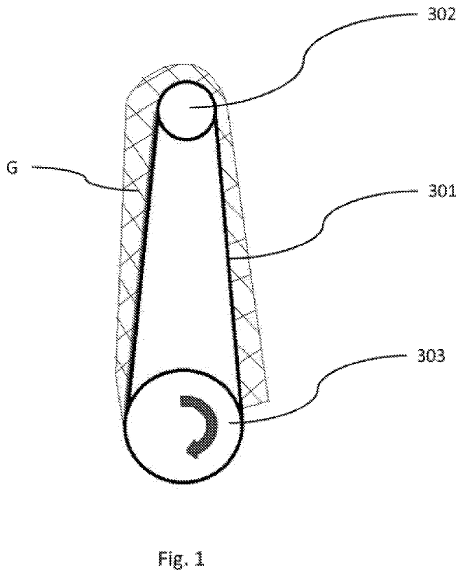

FIG. 1 shows a schematic representation of the formation of a boundary layer G on a circulating grinding belt 301 (grinding element). In the exemplary illustration shown, the grinding belt 301 is picked up vertically by a top deflection roller 302 and a bottom deflection roller 303 and is driven in a clockwise direction.

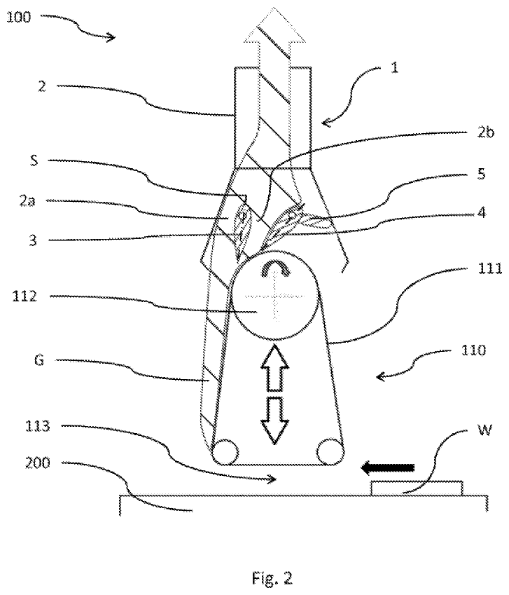

As can also be seen in FIG. 1, a boundary layer G is created as a result of the friction between a surface of the grinding belt 301 and the air contiguous to the surface of the grinding belt. In other words, the contiguous air is swept along by the grinding belt 301 due to the friction. It is also evident from FIG. 2 that the thickness of the boundary layer respectively increases from one deflection roller 302, 303 to the other deflection roller 302, 303. As is also shown in FIG. 1, however, the thickness decreases again along the circumference of the two deflection rollers 302, 303 (as shown on the top deflection roller 302). The thickness of the boundary layer is largely dependent on the circulation speed of the grinding belt 301: The higher the circulation speed is, the heavier or thicker the boundary layer G is that forms on the grinding belt 301, in particular between a surface of the grinding belt and the contiguous air. The thickness of the boundary layer is further dependent on the nature of the grinding belt 301, such as the roughness of the grinding belt 301, for example.

FIG. 2 shows an embodiment of a belt grinding device 100 according to the present invention, in which machining takes place in the same direction. As can be seen in FIG. 2, the belt grinding device 100 (grinding device) has a suctioning device 1 and a grinding unit 110. The grinding unit 110 has a deflection roller which is configured, by way of an example, as tensioning roller 112 in the present embodiment and is used to tension a grinding belt 111. In addition, the grinding belt 111 has a grinding area 113 which is configured to come into contact with a workpiece W to perform grinding work on the workpiece W. Typically, grinding units are arranged vertically across a conveyor 200 which is provided to convey the workpieces W to be machined, and the grinding units are preferably designed so that they are movable vertically, in other words are therefore deliverable to the workpiece W to be machined.

The suctioning device 1 shown has a suctioning hood in which the suctioning channel 2 is formed. As can likewise be seen from FIG. 2, the suctioning hood is designed so that it fully encompasses the tensioning roller 112 at the top, allowing a suctioned air flow to form which is able to fully cover the tensioning roller 112. To create the suctioned air flow, the suctioning device 1 can have a vacuum device (not shown) or be connected to an external vacuum device which is part of a central suctioning unit for particles (chippings) created, for example.

As can also be seen from FIG. 2, the suctioning device 1 has a first manipulation apparatus 3 and a second manipulation apparatus 4 which are both arranged in the suctioning channel 2 provided in the suctioning hood. The two manipulation apparatuses 3, 4, in particular the flow bodies of the manipulation apparatuses 3, 4 have a flow-optimized shape in the cross-section, in particular a wing shape, and are aligned parallel to each other in their longitudinal extent and parallel to the longitudinal extent of the tensioning roller 112 of the grinding unit 110. This enables a distance A between an end of the manipulation apparatuses 3, 4 facing the tensioning roller 112 and the tensioning roller 112 to be altered in each case by pivoting the two manipulation apparatuses 3, 4. As a result, a relative angular position between the two manipulation apparatuses 3, 4 and the tensioning roller 112 and the grinding belt 111 circulating on the tensioning roller 112 can also be changed.

The boundary layer G already described in connection with FIG. 1 which is created by the running movement of the grinding belt 111 during operation of the grinding unit 110 is also shown in FIG. 2. As can also be seen from FIG. 2, the two manipulation apparatuses 3, 4 are aligned, in particular in relation to the grinding belt 111 circulating on the tensioning roller 112, so that they influence the boundary layer G. Specifically, the two manipulation apparatuses 3, 4 are arranged in such a manner in the suctioning channel 2 and aligned in relation to the grinding belt 112 that a line of symmetry S of the two manipulation apparatuses 3, 4 is aligned substantially tangentially to the circulating grinding belt 111. The line of symmetry S runs through the centre of rotation of the manipulation apparatuses 3, 4 and lies on a plane that is perpendicular to the longitudinal extent of the tensioning roller 112.

As the tensioning roller 112 is a top deflection roller of the grinding unit 110, and two deflection rollers (longitudinal unit with calibration roller), for example, can be present in the bottom area of the grinding unit 110, the grinding belt 111 spans, in the cross-section, a trapezium that widens downwardly. The grinding belt would also span a trapezium that widens downwardly if it were a grinding unit 110 with a contact roller, as in this case the contact roller (bottom roller) has a larger diameter than the tensioning roller, as shown in FIG. 1.

As can also be seen from FIG. 2, the grinding belt 111 circulates in a clockwise direction, resulting in a grinding of the workpiece W, which is conveyed in the same direction from right to left through the conveyor 200 shown in FIG. 2.

The grinding belt 111 accordingly moves upwards on the left-hand side of the tensioning roller 112 and downwards on the right-hand side of the tensioning roller 112. Particles, in particular chippings produced during a grinding operation, are thus conveyed upwards from the grinding area 113 towards the tensioning roller 112, and in particular are swept along through the boundary layer G. Due to the inertia of the particles, these are separated from the grinding belt by the deflection upwards, in other words towards the suctioning channel 2, of the grinding belt 111 on the tensioning roller 112. It is therefore possible to use the kinetic energy of the particles to improve the suctioning efficiency of the suctioning device 1.

Due to the boundary layer G, however, many particles are bonded in the boundary layer G on known suctioning devices 1 and prevented from breaking away from the grinding belt 111. In other words, the force of inertia of the particles which acts radially outwards, in other words away from the grinding belt 111, on deflection of the grinding belt 111, is not sufficient to release the particles from the boundary layer G.

In accordance with the embodiment of the present invention shown in FIG. 2, however, the first manipulation apparatus 3 is arranged and aligned such that it influences the boundary layer G. In other words, the flow behaviour of the boundary layer G is influenced, and in particular is influenced such that the boundary layer G is broken up or completely eliminated. To this end, the first manipulation apparatus 3 can be arranged and aligned so that the end of the first manipulation apparatus 3 facing the grinding belt 111 is at a sufficiently small distance from the surface of the grinding belt, such that it is at least partially immersed in the boundary layer G. Due to the immersion of the first manipulation apparatus 3 in the boundary layer G, the latter is broken up and divided into two suctioned air flows 2a, 2b, as seen in FIG. 2. In FIG. 2, the first suctioned air flow 2a flows past the first manipulation apparatus 3 on the left-hand side and upwards, and the second suctioned air flow 2b flows past the first manipulation apparatus 3 on the right-hand side and upwards in FIG. 2. The broken boundary layer G is thus mixed with the ambient air of the suctioning unit 110 suctioned by the suctioning device 1, so that the particles bonded in the boundary layer G can be released and suctioned.

According to the embodiment of the present invention shown, the kinetic energy of the particles bonded in the boundary layer G is accordingly used to release the particles from the boundary layer G. In other words, the particles bonded in the boundary layer G hit the first manipulation apparatus 3 with their kinetic energy, which acts on an entry point on the first manipulation apparatus 3 in a roughly upwardly direction, so that the particles can be deflected. The particles which are deflected to the left in the first suctioned air flow 2a in particular are released from the boundary layer G, whereby the efficiency of the suctioning device 1 can be improved.

However, since a scenario can arise where the boundary layer G cannot be fully broken up or eliminated by the first manipulation apparatus 3, the embodiment shown of the present invention has a second manipulation apparatus 4, which is arranged in a direction of circulation behind the first manipulation apparatus 3. In this way, the second manipulation apparatus 4 can completely break up and eliminate a possibly remaining boundary layer G. Furthermore, the second manipulation apparatus 4 is used to guide the second suctioned air flow 2b upwards in the direction of suctioning.

As can likewise be seen from FIG. 2, it is advantageous if the distance between the manipulation apparatuses 3, 4 and the surface of the grinding belt is smaller for the second manipulation apparatus 4 than for the first manipulation apparatus, as it can be assumed that the thickness of the boundary layer G is substantially smaller in the area of the second manipulation apparatus 4.

In accordance with the embodiment shown in FIG. 2 of the present invention, a sealing device 5 is further provided which is used to seal or close the suctioning channel 2 located behind the second manipulation apparatus 4 in the direction of circulation in order to increase the suction capacity of the suctioning device 1 in the area in which it is required, namely in the area of the suctioning channel 2 in which the two suctioned air flows 2a, 2b flow.

Furthermore, the embodiment of the present invention shown is advantageously equipped with a blowing air device (not shown in detail in the figures). The blowing air device has a plurality of nozzles which are respectively provided on the two manipulation apparatuses 3, 4, in particular at the respective end of the manipulation apparatus 3, 4 which is facing the grinding belt 111.

As shown, it is particularly advantageous if the nozzles are provided in the tip of the manipulation apparatus 3, 4, in particular in the tip of the flow body of the manipulation apparatus 3, 4, such that a blowing direction of the nozzles runs parallel to the line of symmetry S of the manipulation apparatuses 3, 4.

Using blowing air (fluid) which can be blown through the nozzles towards the grinding belt 111, in particular towards the boundary layer G, it is possible to boost the effect of breaking up the boundary layer G. Furthermore, the provision of the blowing device offers the advantage that the manipulation apparatuses 3, 4 can be set further away from the grinding belt 111, with sufficient influence nevertheless still being able to be exerted on the boundary layer G. This is particularly advantageous if the grinding belt 111 is already showing an advanced state of wear and is possibly no longer running smoothly. In other words, due to the increased distance between the manipulation apparatuses 3, 4 and the grinding belt 111, it is less likely that the grinding belt 111 will come into contact with the manipulation apparatuses 3, 4.

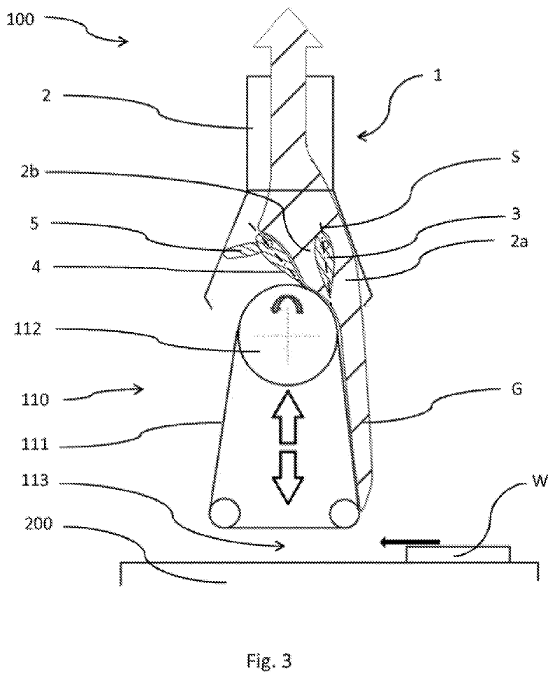

FIG. 3 shows an embodiment of the suctioning device 1 of the present invention as depicted in FIG. 2 which corresponds to the embodiment shown in FIG. 2, merely with the difference that grinding is performed in the counter direction. The grinding belt 111 is accordingly driven anti-clockwise. Due to the anti-clockwise operation, it is necessary to adjust the arrangement and alignment of the manipulation apparatuses 3, 4 and the sealing device 5.

To this end, it is advantageous that the top deflection roller is a tensioning roller 112. It is thus possible to easily lower the tensioning roller 112 in relation to the manipulation apparatuses 3, 4 and thus create clearance for the manipulation apparatuses 3, 4 so that they can be pivoted from a position on the left-hand side in relation to the tensioning roller 112 to a position on the right-hand side. In this respect, it is also conceivable that the suctioning device 1, in particular the suctioning hood is designed so as to be movable upwards.

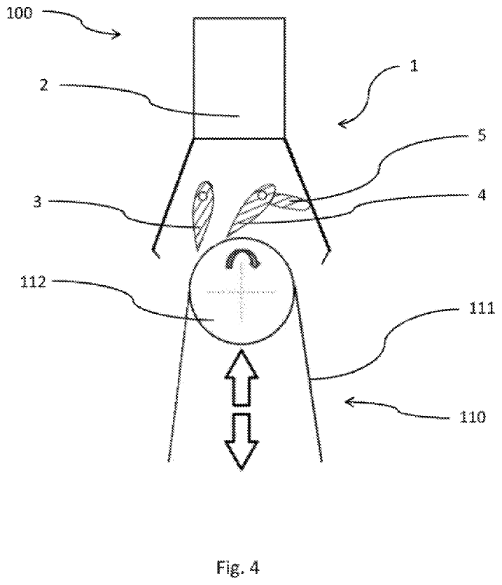

FIG. 4 shows the belt grinding device 1 in a state where the tensioning roller 112 has been lowered and/or the suctioning device 1 has been raised. The distance between the manipulation apparatuses 3, 4 and the tensioning roller 112 is accordingly increased until the manipulation apparatuses 3, 4 can be freely pvioted from the left-hand side of the tensioning roller 112 to the right-hand side of the tensioning roller 112 and vice versa. In other words, in order to be able to change the shown embodiment of the present invention from counter direction grinding over to same direction grinding it is necessary to be able to increase the distance between the two manipulation apparatuses 3, 4 and the tensioning roller 112.

1. A suctioning device for a grinding device having a grinding element, said suctioning device for suctioning particles produced during machining of a workpiece which consists at least in part of wood, composite wood materials, wood substitute materials, plastic, metal or similar, comprising:
at least a suctioning channel through which suctioned air can flow, and
a first manipulation apparatus arranged in the area of the suctioning channel,
characterized in that
the first manipulation apparatus is configured to influence a boundary layer of a grinding element to reach into the boundary layer.

2. The suctioning device according to claim 1, wherein the first manipulation apparatus is arranged so as to be movable wherein the first manipulation apparatus is movable such that an end of the first manipulation apparatus which is facing the boundary layer approaches or moves away from the boundary layer.

3. The suctioning device according to claim 1, further comprising a second manipulation apparatus which is arranged in the suctioning channel so as to be movable wherein the second manipulation apparatus is movable such that an end of the second manipulation apparatus which can be facing the boundary layer approaches or moves away from the boundary layer.

4. The suctioning device according to claim 1, wherein at least a sealing device is further provided which is arranged in the suctioning channel such that it can seal at least part of a cross-section of the suctioning channel so that no suctioned air can flow through this part of the cross-section.

5. The suctioning device according to claim 1, wherein a blowing air device is further provided.

6. The suctioning device according to claim 5, wherein the blowing device has the following:
a plurality of nozzles which are provided in the first and/or the second manipulation apparatus and
flow channels which supply the nozzles with compressed air.

7. The suctioning device according to claim 1, wherein the first manipulation apparatus and/or the second manipulation apparatus has/have an aerodynamic shape, and/or the surface of the first manipulation apparatus and/or the second manipulation apparatus is/are designed as a sharkskin surface or a surface with dimples.

8. The suctioning device according to claim 7, wherein the two manipulation apparatuses can be aligned in relation to the boundary layer in such a manner that two suctioned air flows can be created.

9. The suctioning device according to claim 1, wherein at least one of a plurality of sensors is provided to detect a position of the first manipulation apparatus and/or the second manipulation apparatus and/or the sealing device.

10. The suctioning device according to claim 1, wherein the suctioning device is designed so as to be arranged in a deflection area of a tensioning roller of the grinding element, wherein the first manipulation apparatus and/or the second manipulation apparatus can be brought into contact at least roughly with the tensioning roller.

11. A grinding device for grinding workpieces which consist at least in part of wood, composite wood materials, wood substitute materials, plastic, metal or similar, comprising:
at least a grinding element, wherein the grinding element has a boundary layer during a grinding operation, and
the suctioning device according to claim 1.

12. The grinding device according to claim 11, further comprising a grinding unit with a tensioning roller and/or a deflection roller, wherein the suctioning device is provided in the vicinity of the tensioning roller or deflection roller of the grinding element, wherein the first manipulation apparatus and/or the second manipulation apparatus is/are movable so that it/they can be brought into contact at least roughly with the tensioning roller.

13. The grinding device according to claim 11, wherein the suctioning device and/or the grinding unit is/are movable in order to be able to reduce or increase a distance between the suctioning device and grinding unit, in particular between the first manipulation apparatus and the tensioning roller.

14. Grinding device according to claim 11, further comprising a control device, which is configured to perform at least a positioning and/or angular position of the first manipulation apparatus, of the second manipulation apparatus or of the sealing device based on at least one parameter selected from the following: grinding element type, grinding element grain, circulation speed of the grinding element, material of the workpiece to be machined, particle size and suctioning speed.

15. A method for suctioning particles produced at a grinding device particular during machining of a workpiece, which preferably consists at least in part of wood, composite wood materials, wood substitute materials, plastic, metal or similar, preferably using the suctioning device according to claim 1, comprising the following steps:
creation of at least one suctioned air flow in a suctioning channel for suctioning at least particles sticking to a grinding element;
positioning and/or alignment and/or angular adjustment of a first manipulation apparatus such that the first manipulation apparatus influences a boundary layer.
